(19) United States
(12) Patent Application Publication
(10) Pub. No.: US 2007/0088914 A1
(43) Pub. Date: Apr. 19, 2007

(54) Method and electronic device for selective transfer of data from removable memory element

(76) Inventors: Anuradha K. Soman, Miramar, FL (US); Eric T. Eaton, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/250,653

(22) Filed: Oct. 14, 2005

(51) Int. Cl. G06F 12/00

(52) U.S. Cl. 711/115

(57) ABSTRACT

The invention concerns a method (300) and electronic device (100) for the selective transfer of data from a removable memory element (110). The electronic device can include a port (120) that can receive the removable memory element, a memory (116) that can selectively store data from the removable memory element and a processor (114) that can be coupled to the port and the memory. The processor can be programmed to detect (316) a removal event in which the removal event can provide an indication that the removal of the removable memory element is about to occur and in response to the detection, selectively transfer (318) data from the removable memory element to the memory. The processor can be further programmed to transfer data from the removable memory element to the memory only if the data has been used by an application of the electronic device.

### BACKGROUND OF THE INVENTION

1. Field of the Invention

This invention relates in general to removable memory elements and the devices that accept them, and more particularly, to the transfer of information between removable memory elements and such devices.

2. Description of the Related Art

The use of portable electronic devices has risen in recent years. Cellular telephones and other communication devices, in particular, have become very popular with the public. In an effort to distinguish their products, manufacturers of these devices have implemented numerous features into them. One example of such a feature is a removable memory element port or slot, which can accept a removable memory element, like a memory card. To date, however, there has been a lack of efficient management of the transfer of data between the memory card and portable electronic devices.

### SUMMARY OF THE INVENTION

The present invention concerns an electronic device. The electronic device can include a port that can receive a removable memory element, a memory that can selectively store data from the removable memory element and a processor that can be coupled to the port and the memory. The processor can be programmed to detect a removal event in which the removal event can provide an indication that the removal of the removable memory element is about to occur and in response to the detection, selectively transfer data from the removable memory element to the memory. As an example, the processor can be further programmed to transfer data from the removable memory element to the memory only if the data has been used by an application of the electronic device.

In one arrangement, the electronic device can further include a detection mechanism that can be coupled to the processor. The detection mechanism can monitor for the removal event and can signal the processor when it detects the removal event. As an example, the electronic device can include a door that can selectively cover the port, and the detection mechanism can detect the opening of the door as the removal event. As another example, the electronic device can further include a holding component that can temporarily hold the removable memory element to allow the transfer of data from the removable memory element to the memory. The detection mechanism can detect the holding of the removable memory element as the removal event. As yet another example, the electronic device can include a user interface that can receive input from a user, and the detection mechanism can detect the input from the user as the removal event.

In one arrangement, the electronic device can be a mobile communications device, and the data can include digital pictures, audio files or ring tones. Also, the removable memory element can be a flash memory card. In yet another arrangement, the processor can be further programmed to determine the engagement of the removable memory element or a second removable memory element and determine whether the data stored in the memory was previously present in the removable memory element or the second removable memory element. If the data was previously present, the processor can be further programmed to transfer the data back to the removable memory element or the second removable memory element. The data from the removable memory element may be encrypted, and the processor can be further programmed to decrypt the data upon receipt of a user credential.

The present invention also concerns a method of transferring data. The method can include the steps of—in an electronic device—receiving a removable memory element that stores data, detecting a removal event in which the removal event can provide an indication that the removal of the removable memory element is about to occur and in response to detecting the removal event, selectively transferring data from the removable memory element to a memory of the electronic device. As an example, selectively transferring the data can further include selectively transferring the data from the removable memory element to the memory only if the data has been used by an application of the electronic device.

The present invention also concerns a machine readable storage, having stored thereon a computer program having a plurality of code sections executable by an electronic device. The computer program can cause the electronic device to perform the steps of receiving a removable memory element that stores data, detecting a removal event in which the removal event can provide an indication that the removal of the removable memory element is about to occur and in response to detecting the removal event, selectively transferring data from the removable memory element to a memory of the electronic device. In addition, the computer program can further cause the electronic device to selectively transfer the data from the removable memory element to the memory only if the data has been used by an application of the electronic device. The computer program can also cause the communications device to perform any of the above-described processes.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an electronic device and a removable memory element in accordance with an embodiment of the inventive arrangements;

FIG. 2 illustrates a block diagram of an example of an electronic device in accordance with an embodiment of the inventive arrangements; and

FIG. 3 illustrates a method for transferring data in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “module” can be defined as any combination of hardware and/or software to enable an appropriate function to be performed.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system. Where suitable, the term “application” may even refer to a hardware setting or component.

The present invention concerns a method and an electronic device. The electronic device can include a port that receives a removable memory element, a memory that selectively stores data from the removable memory element and a processor coupled to the port and the memory. The processor can be programmed to detect a removal event in which the removal event can provide an indication that the removal of the removable memory element is about to occur and in response to the detection, selectively transfer data from the removable memory element to the memory. In one arrangement, the processor can be further programmed to transfer data from the removable memory element to the memory only if the data has been used by an application of the electronic device. This selective transfer of data can free up memory space in the electronic device.

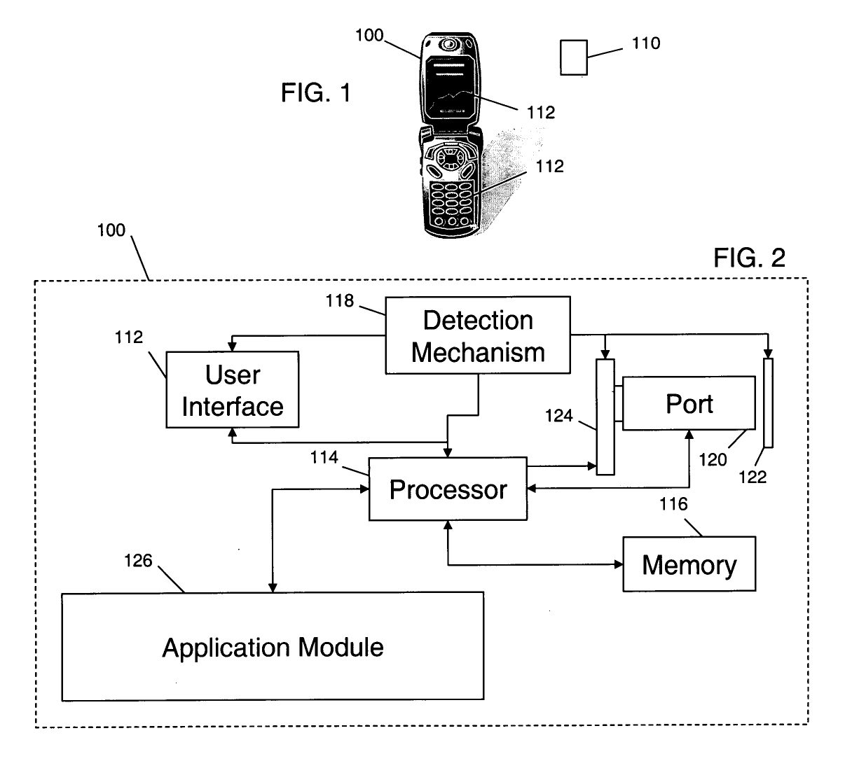

Referring to FIG. 1, an electronic device 100 and a removable memory element 110 are shown. In one arrangement, the electronic device 100 can be a mobile communications device, such as a cellular telephone or two-way radio. Of course, the electronic device 100 can be any other suitable electrical component. In fact, the electronic device 100 can even be a hard-wired component. The removable memory element 110 can store any suitable type of data. As an example, the removable memory element 110 can be a flash memory card and can be capable of storing digital pictures, audio files or ring tones. The removable memory element 110, however, can be any suitable storage device capable of holding data, and the invention is certainly not limited to the examples cited above.

In one arrangement, the electronic device 100 can be designed to receive the removable memory element 110. Once received and as will be explained later, data from the removable memory element 110 can be selectively transferred to the electronic device 100. Any suitable type of application or component in the electronic device 100 can utilize the data from the removable memory element 110 in any suitable manner.

Referring to FIG. 2, a block diagram of an example of the electronic device 100 is shown. In this example, the electronic device 100 can include one or more of the following: a user interface 112, processor 114, a memory 116, a detection mechanism 118, a port 120, a door 122, a holding component 124 and an application module 126.

The processor 114 can be coupled to and control the operation of the user interface 112, the memory 116, the application module 126 and the port 120. For purposes of the invention, the term processor can include any suitable number of components capable of executing instructions to perform the processes associated with the inventive arrangements. In addition, although the memory 116, the detection mechanism 118 and the application module 126 are shown as discrete components, any number of these elements may actually be part of or integrated with the processor 114. In another arrangement, the processor 114 can be programmed to decrypt data from the removable memory element 110, if such a feature is desired.

The user interface 112 can be a keypad or a display, as shown in FIG. 1. The user interface 112 can receive input from a user and can signal the processor 114 with such input. In addition, the memory 116 can be any suitable type of memory for storing any suitable type of data for operation of the electronic device 100. In one arrangement, data from the removable memory element 110 can be selectively transferred to the memory 116. As an example, the application module 126 can include various applications of the electronic device 100 that may use the data from the removable memory element 110. For example, the application module 126 may include a caller identification (ID) program that identifies a caller by displaying a digital picture of the caller. The picture of the caller may be initially stored on the removable memory element 110. When loaded into the electronic device 100, however, the picture can be selectively loaded into the memory 116, and the caller ID program can access this picture when the appropriate caller calls the electronic device 100. This example is merely one of many that are applicable to the invention, and the invention is in no way limited to it.

The port 120 can receive the removable memory element 110. As an example, the port 120 can be a slot in the electronic device 100 that is capable of receiving a memory card and which has electronic circuitry embedded in it to facilitate the transfer of data from the memory card. In one arrangement, the electronic device 100 can include a door 122 that can control access to the port 120. The door 122 can be moved to an open position to allow the removable memory element 110 to be inserted into or removed from the electronic device 100. The door 122 may also be moved to a closed position to cover the port 120. The detection mechanism 118 can determine whether the door 122 is in the open or closed position and can signal the processor 114 with such information.

The holding component 124 can temporarily hold the removable memory element 110, which can allow the transfer of data from the removable memory element 110 to the memory 116. For example, if a user wishes to remove the removable memory element 110 from the electronic device 100, the user may push down on the top of the element 110. As is known in the art, the port 120 may include a spring-loaded release mechanism (not shown) that can, after the user pushes down on the element 110, force the element 110 in the opposite direction and away from the electronic device 100. This process can provide a user with access to the element 110, which can permit the user to grasp the element 110 and remove it from the electronic device 100.

In one arrangement, the holding component 124 can temporarily hold the removable memory element 110 in place after the user pushes down on the element 110. As an example, the holding component 124 can hold the memory element 110 until at least a portion of the data on the element 110 is transferred to the memory 116 of the electronic device 100. As another example, the detection mechanism 118 can determine when the holding component 124 receives the memory element 110 for temporary holding and can signal the processor 114. In addition, when the transfer of the data is complete, the processor 114 or the detection mechanism 118 can signal the holding component 124 to release the removable memory element 110.

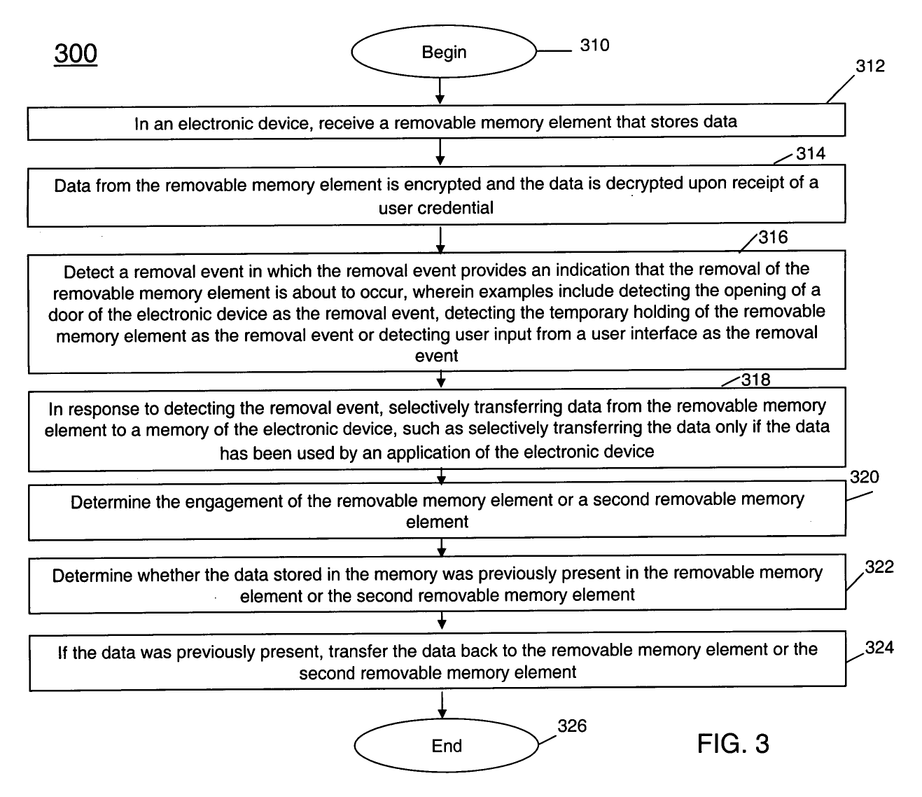

Referring to FIG. 3, a method 300 for transferring data is shown. When describing the method 300, reference will be made to FIGS. 1 and 2, although it must be noted that the method 300 can be practiced in any other suitable system or device. Moreover, the steps of the method 300 are not limited to the particular order in which they are presented in FIG. 3. The inventive method can also have a greater number of steps or a fewer number of steps than those shown in FIG. 3.

At step 310, the method can begin. At step 312, in an electronic device, a removable memory element can be received. At step 314, data from the removable memory element can decrypted upon receipt of a user credential, if such data has been previously decrypted.

For example, referring to FIGS. 1 and 2, a user can insert the removable memory element 110 into the electronic device 100, such as by feeding the element 110 into the port 120. Of course, the device 100 can receive the element 110 in any other suitable fashion. The processor 114 can detect the insertion of the removable memory element 110 in the port 120. In one arrangement, data stored on the removable memory element 110 may be encrypted. If so, a user can enter a user credential, such as a password or a measurable biometric characteristic, like a fingerprint scan, through the user interface 112. Once received, the processor 114 can verify the user credential and in response, can decrypt the data on the memory element 110.

At this point, the electronic device 100 can freely access and use any relevant portion of data on the removable memory element 110. For example, the application module 126 may include a caller ID program or a digital music player program. As such, the processor 114 can access certain pictures or audio files from the removable memory element 110, and this data can be used by the appropriate program in the application module 126. For example, if a particular caller calls the device 100, the processor 114 can access that person's picture from the memory element 110 and can transfer it to the caller ID program in the application module, which can eventually cause the caller's picture to be displayed. As another example, a desired ring tone can be accessed from the memory element 110 when a call is received at the device 100.

If desired, this data can always be stored and accessed from the removable memory element 110 when needed. In other words, the data is not required to be stored in any memory (or at least a non-volatile memory) of the electronic device 100 when the removable memory element 110 is loaded in the electronic device. This feature can free up large portions of memory in the electronic device 100. It is important to note that the invention is in no way limited to the examples listed above, as any suitable type of data can be used by any suitable type of program or application of the application module.

Referring back to the method 300 of FIG. 3, at step 316, a removal event can be detected, which can provide an indication that the removal of the removable memory element is about to occur. As an example, a removal event can be the detection of an opening of a door of the electronic device or the detection of the temporary holding of the removable memory element. In yet another example, the removal event can be the detection of a user input from a user interface of the electronic device.

At step 318, in response to detecting the removal event, data can be selectively transferred from the removable memory element to a memory of the electronic device. As an example, the data may be selectively transferred only if the data has been used by an application of the electronic device.

For example, referring again to FIGS. 1 and 2, a user may wish to remove the removable memory element 110 from the electronic device 100. As noted earlier, the device 100 may include a door 122 that swings between open and closed positions. The user may open the door 122 to gain access to the removable memory element 110, and the detection mechanism 118 can detect this step and can signal the processor 114. Thus, the opening of the door 122 may be considered a removal event.

Additionally, a user may press down on the memory element 110, as explained above, and the holding component 124 can begin to temporarily hold the element 110. Again, the detection mechanism 118 can detect this process as a removal event and can signal the processor 114. Alternatively, a user may input some information through the user interface 112, such as through pressing one or more buttons on a keypad of the device 100. For example, a user may select from a menu on a display of the device 100 that he or she wishes to remove the removable memory element 110. This selection can also be detected by the detection mechanism 118 as a removal event, which can then signal the processor 114.

Although several examples of removal events are described here, it is important to note that the invention is not limited to any of them. In fact, a removal event can be any action or event that can provide an indication that removal of the removable memory element 110 from the electronic device 100 is about to or is in the process of occurring.

In response to the detection of a removal event, the processor 114 can selectively transfer data from the memory element 110 to the memory 116 of the device 100. As noted above, in one arrangement, data may be selectively transferred only if the data has been used by an application or program of the device 100. For example, if a caller ID program of the application module 126 has accessed a picture from the removable memory element 110, which was displayed when a caller associated with the picture called the device 100, the processor 114 can transfer the picture from the memory element 110 to the memory 116. After the transfer, the picture can be used by the caller ID program in the application module 126, even when the removable memory element 110 is removed from the device 110.

This selective transfer can apply to data that has been used by applications or programs of the device 100, including other pictures or ringtones and audio files. If a portion of data was not used, then it is unnecessary to transfer that data from the removable memory element 110 to the memory 116. As such, only relevant data is transferred from the element 110, which can save memory space in the device 100. It must be noted that the invention is not limited to this example, as all the data or portions of the data that were never used by the device 100 can be transferred to the memory 116.

As an example, the time frame to earmark data for transfer can be from the time the memory element 110 is first put in the device 100 until the removal event is detected. Thus, any data that has been used during this time can be transferred to the memory 116. Of course, time restrictions or even geographical restrictions can be placed on the transfer of the data. For example, a user could program the device 100 to only transfer data that has been accessed during a particular time frame or at a particular geographical location. As another example, a frequency limit can be implemented in the device 100. For example, it can be decided that data may only be transferred if it has been accessed or used a predetermined minimum number of times by the device 100.

Once the data has been transferred, the user can remove the removable memory element 110 from the device 100. For example, the processor 114 can signal the detection mechanism 118 once the transfer is complete, and the detection mechanism 118 can signal the holding component 124 and/or the user interface 112. In response, the holding component 124 can release the memory element 110 and/or the user interface 112 can inform the user that it is safe to remove the element 110. Those of skill in the art will appreciate that there are numerous ways to maintain or at least encourage to maintain the removable memory element 110 in engagement with the device 100 until the data is transferred from it.

Referring once again to FIG. 3, at step 320, the engagement of the removable memory element or a second removable memory element can be determined. It can then be determined whether the data stored in the memory was previously present in the removable memory element or the second removable memory element, as shown at step 322. If the data was previously present, the data can be transferred back to the removable memory element or the second removable memory element, as shown at step 324. At step 326, the method 300 can end.

For example, referring back to FIGS. 1 and 2, the removable memory element 110 or a different (second) removable memory element 110 can be inserted into the port 120, which can be detected by the processor 114. The processor 114 can then determine whether data stored in the memory 116 was previously stored in the removable memory element 110 or the second removable memory element 110. As an example, the removable memory element 110 can include one or more tags, file names or other suitable types of information that the processor 114 can check against the data stored in the memory 116.

If the processor 114 determines that data that is currently stored in the memory 116 was previously stored in the memory element 110 or the second memory element 110, then the processor 114 can transfer this data back to the element 110 or the second element 110. By doing so, more space in the memory 116 can be made available once the removable memory element 110 (or a different element) is reinserted into the device 100.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An electronic device, comprising:
a port that receives a removable memory element;
a memory that selectively stores data from the removable memory element; and
a processor coupled to the port and the memory, wherein the processor is programmed to:
detect a removal event, wherein the removal event provides an indication that the removal of the removable memory element is about to occur; and
in response to the detection, selectively transfer data from the removable memory element to the memory.

2. The electronic device according to claim 1, wherein the processor is further programmed to transfer data from the removable memory element to the memory only if the data has been used by an application of the electronic device.

3. The electronic device according to claim 1, further comprising a detection mechanism coupled to the processor, wherein the detection mechanism monitors for the removal event and signals the processor when it detects the removal event.

4. The electronic device according to claim 3, further comprising a door that selectively covers the port and wherein the detection mechanism detects the opening of the door as the removal event.

5. The electronic device according to claim 3, further comprising a holding component that temporarily holds the removable memory element to allow the transfer of data from the removable memory element to the memory and wherein the detection mechanism detects the holding of the removable memory element as the removal event.

6. The electronic device according to claim 3, further comprising a user interface that receives input from a user and wherein the detection mechanism detects the input from the user as the removal event.

7. The electronic device according to claim 1, wherein the electronic device is a mobile communications device and the data includes digital pictures, audio files or ring tones.

8. The electronic device according to claim 1, wherein the removable memory element is a flash memory card.

9. The electronic device according to claim 1, wherein the processor is further programmed to:
determine the engagement of the removable memory element or a second removable memory element;
determine whether the data stored in the memory was previously present in the removable memory element or the second removable memory element; and
if the data was previously present, transferring the data back to the removable memory element or the second removable memory element.

10. The electronic device according to claim 1, wherein the data from the removable memory element is encrypted and the processor is further programmed to decrypt the data upon receipt of a user credential.

11. A method of transferring data, comprising:
in an electronic device, receiving a removable memory element that stores data;
detecting a removal event, wherein the removal event provides an indication that the removal of the removable memory element is about to occur; and
in response to detecting the removal event, selectively transferring data from the removable memory element to a memory of the electronic device.

12. The method according to claim 11, wherein selectively transferring the data further comprises selectively transferring the data from the removable memory element to the memory only if the data has been used by an application of the electronic device.

13. The method according to claim 11, further comprising detecting the opening of a door of the electronic device as the removal event.

14. The method according to claim 11, further comprising:
temporarily holding the removable memory element to allow the transfer of data from the removable memory element to the memory; and
detecting the holding of the removable memory element as the removal event.

15. The method according to claim 11, further comprising:
receiving input from a user through a user interface of the electronic device; and
detecting the input of the user as the removal event.

16. The method according to claim 11, wherein the electronic device is a mobile communications device and the data includes digital pictures, audio files or ring tones.

17. The method according to claim 11, further comprising:
determining the engagement of the removable memory element or a second removable memory element;
determining whether the data stored in the memory was previously present in the removable memory element or the second removable memory element; and
if the data was previously present, transferring the data back to the removable memory element or the second removable memory element.

18. The method according to claim 11, wherein the data from the removable memory element is encrypted and the method further comprises decrypting the data upon receipt of a user credential.

19. A machine readable storage, having stored thereon a computer program having a plurality of code sections executable by an electronic device for causing the electronic device to perform the steps of:
receiving a removable memory element that stores data;
detecting a removal event, wherein the removal event provides an indication that the removal of the removable memory element is about to occur; and
in response to detecting the removal event, selectively transferring data from the removable memory element to a memory of the electronic device.

20. The machine readable storage according to claim 19, wherein the computer program further causes the electronic device to selectively transfer the data from the removable memory element to the memory only if the data has been used by an application of the electronic device.
